(19) United States
(12) Patent Application Publication
(10) Pub. No.: US 2012/0243434 A1
(43) Pub. Date: Sep. 27, 2012

(54) Spatial protocol for peer to peer networking using spatial binary active matrix

(76) Inventor: James M. Butler, Saratoga, CA (US)

(21) Appl. No.: 13/065,314

(22) Filed: Mar. 21, 2011

(51) Int. Cl. H04L 12/28

(52) U.S. Cl. 370/254

(57) ABSTRACT

Binary data is used to describe relative location and can be used to determine routing topology in wired or wireless network environments. A standardized matrix is populated based on capacity, bandwidth, and location. This method requires less data and is reduced to binary form for faster process at the Transport layer. Furthermore, the same binary sequence communicates the relative topology and is used to route data in complex and moving environments. Each numeric sequence can also communicate the bandwidth, capacity and node rating.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

Geographic or position based fixed and mobile protocols have been toyed with much in academia for about a decade between the mid 1990's to mid 2000's. They are broken down into 3 categories greedy forwarding, restricted directional flooding, and hierarchical methods. Furthermore, the above groups can be broken down into proactive, reactive and hybrid systems.

We use the term ‘spatial’ instead of ‘geographic’ since actual longitude at latitude coordinates, or earth related data, is not necessary to route spatial traffic. Any spatial system can be used to route data given a logic coordinate system. Absent a coordinate system, a triangulation algorithm will suffice to derive distance and direction. Global Positioning System (GPS) coordinates are included in the ‘spatial’ term.

“Location Systems for Ubiquitous Computing”, a published paper by Hightower and Borellio, discusses the details of physical location and symbolic location, accuracy and scales for networks, and locations using a coordinate system.

A network may also assign location itself without GPS, or the manual assignment of location as noted in “GPS Free Positioning in Mobile Ad Hoc Networks” published by Srdjan Capkun, Maher Hamdi, and Jean Pierre Hubaux. They use local triangulation calculations to determine the location of a fixed or ad hoc network. Regardless of the method used, the destination location is added to the base layer of the data packet as noted in FIG. 1.

My “Bounce” system is a significant leap from predecessors because the predecessors use one layer of logic to make peer-to-peer negotiation typically based on the hosting node. “GPSR: Greedy Perimeter Stateless Routing for Wireless Networks” by Brad Karp and H. T. Kung of Harvard use specific rules for nodes logic to route packets through challenging topologies based solely on the local node location and the destination location listed in the packet. Other systems depend heavily on a Grid Location Service (GLS) like GRID. GLS maps the location of the nodes that are all kept in a database.

Given the aforementioned methods, each attempts to minimize the inherent challenges of this protocol. The most challenging tasks for spatial protocols are:
1) Navigation to a destination given time and space constraints—packets may get trapped in looping routes, dead ends or changing topology.
2) Bandwidth overhead for self-managing communication—this is the bandwidth used to manage ad hoc networks, which are very high due to the complexity of moving peers. This bandwidth may consume more transmitting traffic yielding low throughput of valuable traffic.
3) Peer-to-peer coordination—each node communicates its location and the location of other peers within its broadcasting range. This has to be done frequently and uses valuable bandwidth.
4) Node resources—Each node must store some information. The amount of spatial data that must be stored is extensive which reduces the resources available. The computations necessary for calculating directional decisions are complex which also occupies resources.

### BRIEF SUMMARY OF THE INVENTION

Spatial Binary Active Matrix (S-BAM) inclusively solves the major difficulties. This is a new classification of spatial protocols—Proactive Matrix Forwarding System. I will demonstrate this process. First we will take a random grouping of nodes as noted in FIG. 2. The center node will be the subject, which will serve as our example.

We will build a matrix around the subject node with the expectation to quantify the adjacent (1 hop) nodes within a consistent form of space. The goal for the matrix is to find 4 directions 90 degrees apart within the broadcasting range of the nodes so that the packet traffic can negotiate freely. The matrix size needs to be large enough to connect the node to the 4 passage directions. In this case, the 4 square matrix does not find directions East or North since squares 1, 2 and 4 do not have a node within broadcasting range. Square 3 will provide South and West directional passage. The node square 1 is on the edge of the broadcasting range, so since we want highest probability of directional passage, we will assume this node will not be adequate.

Before we move on to determine the 4 directions of passage, lets determine the size of the matrix squares in FIG. 4. The diagonal line from corner to corner of the square is equal to the broadcasting range. The length of the side of the square is equal to the square root of 2*broadcasting range. The size of the matrix may be smaller for more precise routing, however, when the size of the square fits into the broadcast range, I found optimal results.

Since I have not found the 4 directions of passage from the subject node I will increase the size of the matrix to a 4×4. If you visually inspect the matrix you can see that an Easterly passage is possible if a data packet is sent from the subject node to square 10, 14, 15 then 16. Next we can also see that once we arrive at square 16 we can move north 12, 8, 4 to arrive at a North passage. So, with the 4×4 matrix we can transmit in 4 directions to North, South, East and West by following the matrix.

To summarize matrix passage:

North passage=10, 14, 15, 16, 12, 8, 4

South passage=10, 14

East passage=10, 14, 15, 16

West passage=10, 9

Any data packet negotiating its destination can finds its way away from the subject node. If we store this matrix on adjacent nodes for incoming packets, we can provide correct mapping going in or out of this node despite some complex spatial negotiating.

The problem with most spatial systems is minimizing bandwidth, resources and the computation time to calculate and adjust to changing environments, so we will simplify this process. We will use binary data to communicate the position of an available node given the fact that all squares are the same size and all of the Matrices are oriented by North is up as FIG. 6 demonstrates. Squares with nodes are equal to one and squares absent nodes are zeros.

The matrix in FIG. 7 contains binary data to form a solution set for 4 sided directional passage.

By breaking down the binary node vacancies into octets, we can reduce a complex negotiating map to 2 bytes of data in FIG. 8 below.

We have 2 octets of data to determine the spatial relationship of the subject node. Visually we can see from the binary matrix how we can determine the 4 directions. The nodes can digest the matrix in a dynamic, quickly changing ad hoc environment to process the optimal route.

We can tell from the diagram that this node with access to only one other peer can process access to all 4 directional routes when reduced to a binary matrix. The spatial information required to negotiate to the 4 directions is stored in only 2 octets. This amount of data can be:
1) Stored on very small systems like Zigbee
2) Quickly processed for optimal routing solutions for low processing speed systems
3) Provide extremely complex routing direction in Ad Hoc environments

Lets compare this SBAM table storage data to current methods in terms of node storage in memory, computation time and communication time to copy this table to another node. An ASCII format would require 16 pair of coordinates using GPS format of 9 digits. So, (16*2)*(8 bits)*9=2304 bits of data required to process or communicate the table details, which is 144 times the SBAM method. Conversely, SBAM is 144 times faster and more suitable for sending and receiving routes. SBAM has also predetermined the successful 4 directional passage paths so that processing time in ad hoc environments is minimized. These numbers are a general indication that spatial tables can be communicated faster using fewer resources.

### Topology Changes

The tables are kept active during transmission times. During location movement a node rebuilds its matrix and rebroadcasts the new matrix to adjacent nodes.

### High Security Network Servers

For high security networks a central several can be copied on the binary matrices to create a replica of the nodes in the network for analysis and traffic monitoring.

### Problem Solving/Traffic Detours/Partial Directional Passage

If directional passage of a node is unattainable, then the node may refuse delivery and surrounding node can combine matrices to create a solution. The binary matrices can be linked together since the orientation is the same. The linking logic is like connecting Lego blocks'and connecting each matrix using the same node address relative to its location. Using the same logic to find the 4 directional passages, each node can reuse the existing spatial logic for larger matrices.

### BRIEF DESCRIPTION OF THE SEVERAL VIEWS OF THE DRAWINGS

FIG. 1 TCP/IP type data packet

FIG. 2 Depiction of random group of nodes

FIG. 3 Basic matrix surrounding center node

FIG. 4 Broadcast range of node

FIG. 5 Matrix accommodating a 4-directional passage

FIG. 6 Matrix accommodating a 4-directional passage

FIG. 7 Conversion of matrix to octets

FIG. 8 Conversion of octets to binary code

FIG. 9 Beginning the binary directional conversion

FIG. 10 Identification of the 4-directional conversion

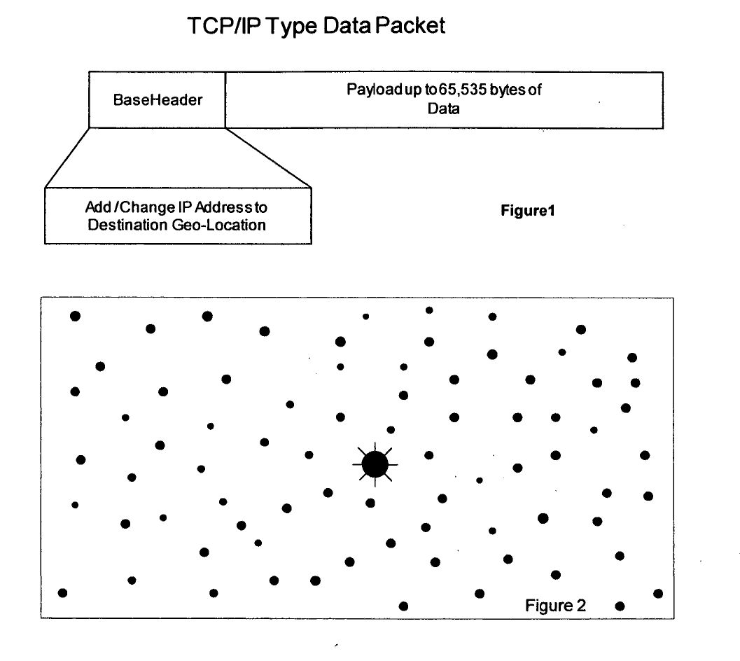

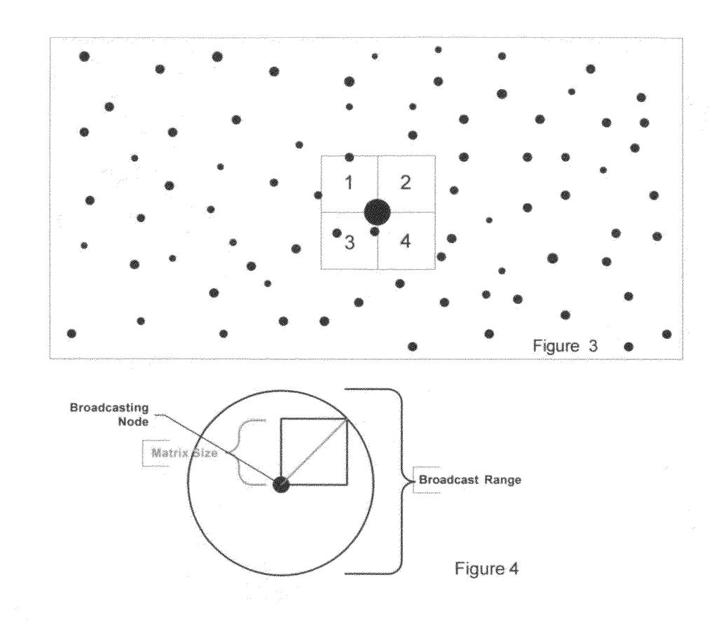

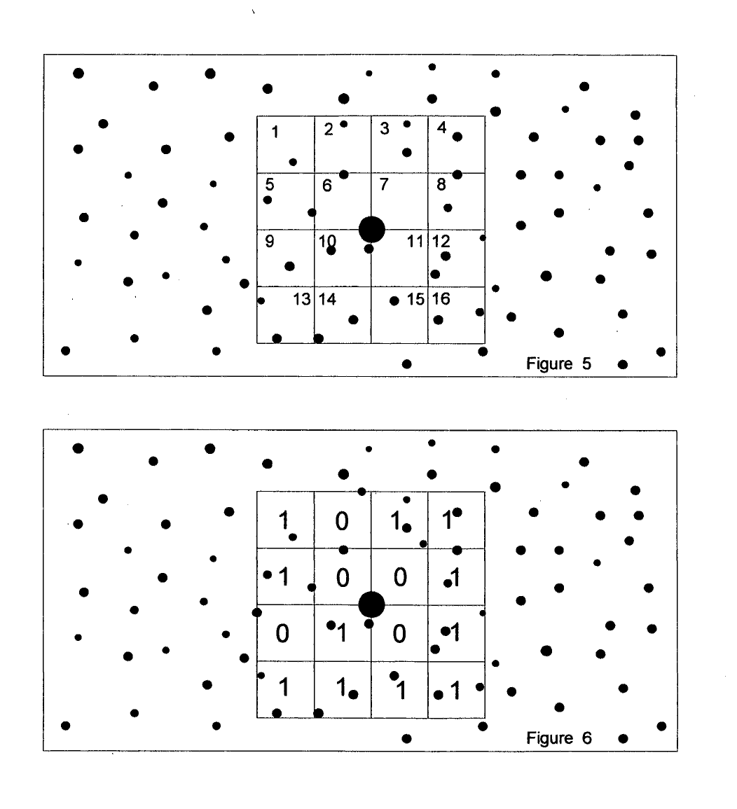

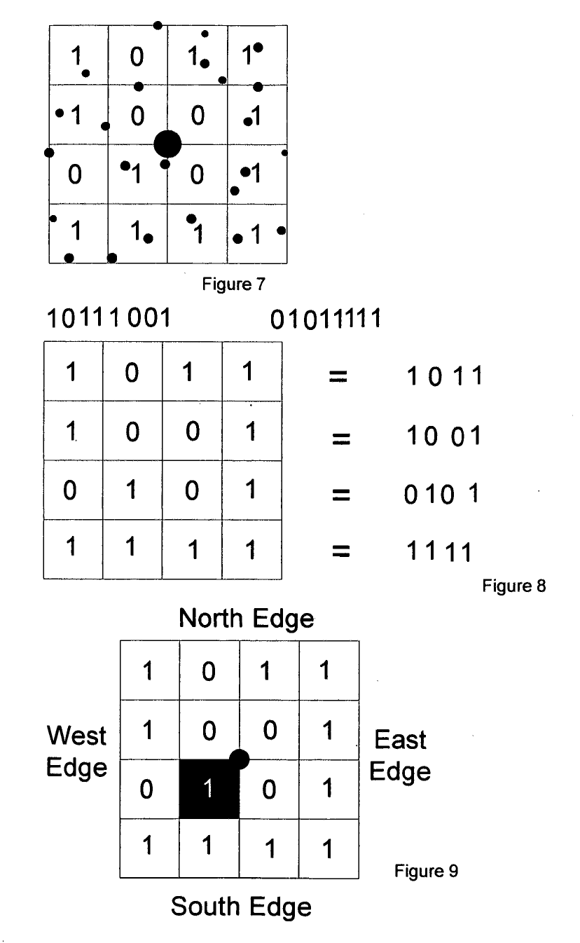

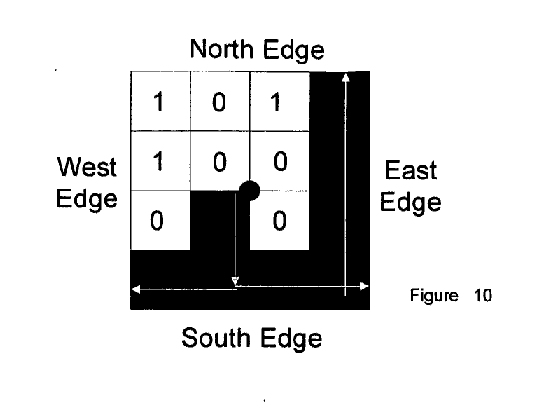

### DETAILED DESCRIPTION OF THE INVENTION

See summary of the invention

1. A method of communicating spatial location and routing topology among wireless or wired devices. Where binary forms of data are used to describe relative location and routing topology

2. The method of claim 1 further defined by establishing a database or Matrix of members of a user group including user identification with spatial or geo-location data utilizing a matrix that employs geographic squares defined by broadcast range of each relative wireless device. Each matrix square is typically being the square root of 2 divided by 2 of the broadcast range. Wired devices use a matrix size of minimum distance between wired devices. All devices use a standard size matrix with a fixed or variable length.

3. Each matrix square represents the physical area of a map where a value (0,1) or (0 to 10) is assigned based on the presence or absence of a networking device. Furthermore, the value may represent signal strength, bandwidth or capacity. Topological routing is based on programmed algorithms to maximize or minimize traffic, bandwidth and capacity of each node. Matrices are scalable and the scales are determined and agreed upon for each device and established.

4. Discovery process is made up of sending out request or scout messages to devices in range proximity and builds the matrix and storing it. The stored matrix may be transmitted to waking devices to speed up discovery process. The stored matrix is used to determine routing paths in complex and moving environments by processing the values stored in the matrix to target node in the spatial direction of intended target. The header with specific the address of the destination node will be transmitted. Re-broadcasting is triggered by changed in the matrix. The changes are where a device has changed its position in or out of its matrix square.
